(19) United States
(12) Patent Application Publication
(10) Pub. No.: US 2007/0115615 A1
(43) Pub. Date: May 24, 2007

(54) Optical head

(75) Inventor: Yutaro Hamatani, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/598,718

(22) Filed: Nov. 14, 2006

(30) Foreign Application Priority Data
Nov. 18, 2005 (JP) 2005-333730

(51) Int. Cl. H02B 1/00

(52) U.S. Cl. 361/600

(57) ABSTRACT

It is an object to save time and effort for operations in assembling and in detaching a radiation cover member when replacing and/or maintaining internal parts as well as to improve the assembling accuracy of the products. In an optical head A having a base 1, an actuator 2, and a cover member 3 for covering the bottom surface of the base 1, on a light source contact portion 321 in a laser light source support portion 32 of the cover member 3, there is formed a convex portion 3211 adapted to be engaged with a key groove 522 that is formed in a flange portion 52 of a laser light source 5.

### BACKGROUND OF THE INVENTION

1. Field of the Invention

The present invention relates to an optical head for recording and (or) reading data by applying a laser beam to an optical disk.

2. Description of the Prior Art

There are utilized optical disks such as CDs (Compact Disks) and DVDs (Digital Versatile Disks), onto/from which information can be recorded and (or) read by applying a laser beam, as media for recording information such as videos and/or audios. Optical heads that utilize such an optical disk as a recording medium are used to apply a laser beam to the recording surface of the optical disk to record data and/or to detect reflected light to read data.

FIG. 7 is a view showing an arrangement in an optical head. The optical head shown in FIG. 7 is, for example, a read-only optical head for reading data recorded on an optical disk, though not restricted thereto. As shown in FIG. 7, there are provided a laser light source 921, a grating Gr for extracting light of specific wavelengths from a laser beam emitted from the laser light source 921, a mirror Mr, a collimator lens Lc, an objective lens Lb, a half mirror Hm, and a light receiving element Pd. A laser beam emitted from the laser light source 921 undergoes extraction of specific wavelengths in the grating Gr and is reflected at the mirror Mr to enter the collimator lens Lc. The laser beam incident to the collimator lens Lc is output as parallel light to enter the objective lens Lb. The laser beam incident to the objective lens Lb is applied to the recording surface of an optical disk Ds.

In the case above, the laser beam is applied focusing on the recording layer of the optical disk Ds with the optical axis thereof being perpendicular to the recording layer of the optical disk Ds. The half mirror Hm is a mirror for transmitting a half of the incident laser beam and for reflecting the other half, adapted to guide the light reflected at the optical disk Ds toward the light receiving element Pd. The light receiving element Pd is adapted to convert light into current and to read data based on the intensity of the light.

FIG. 8 (A) is a bottom view of a conventional optical head and FIG. 8 (B) is a side view of the optical head shown in FIG. 8 (A). The optical head B shown in FIGS. 8 (A) and 8 (B) is provided with a base 91, a laser light source unit 92 attached to the base 91, a grating Gr for diffracting a laser beam, and a cover member 93 for releasing heat generated from the laser light source unit 92.

The base 91 has a light source installing portion 911 for arranging the laser light source unit 92 thereon, in the light source installing portion 911 being formed two diagonally arranged female screw holes 912 and two bosses 913 on the diagonal line different from that on which the female screw holes 912 are formed. A female screw hole 914 is formed also in the bottom surface of the base 91.

The laser light source unit 92 has a laser light source 921 and a laser holder 922. The laser light source 921 is press-fitted and fixed into a through hole that is formed in the laser holder 922.

The cover member 93 is to be attached to the bottom surface of the base 91, having a cover portion 931 for covering the bottom surface, a laser light source holding portion 932 for holding the laser light source unit 92 in a contact manner, and further a grating adjustment window 934 for adjusting the grating Gr, and a tilt adjustment window 935 for adjusting the tilt of an act base 94 that holds the objective lens.

The laser holder 922 with the laser light source 921 press-fitted therein is arranged on the light source installing portion 911 in such a manner that the bosses 913 on the light source installing portion 911 penetrate through boss holes in the laser holder 922. Thus arranging allows the laser holder 922 to be positioned.

Further, the cover member 93 is installed in such a manner that the bosses 913 penetrating through the laser holder 922 are fitted into boss holes formed in the laser light source holding portion 932 of the cover member 93.

The laser holder 922 and cover member 93 can be fixed to each other by inserting and screwing bolts Bt into the female screw holes 912 through the cover member 93. The angle of the laser light source unit 92 can be fine adjusted by adjusting the tightness of the bolts Bt, and therefore the laser light source 921 can be adjusted.

Also, in the invention described in Japanese Patent Laid-Open Publication No. 2005-108300, the rotational position of a laser diode can be specified by arranging the laser diode on an optical base and attaching a holder in a sliding manner from outside. Thus providing the holder allows heat generated from the laser diode to be transferred to the outer holder and thereby the heat of the laser diode to be removed efficiently.

However, in the case of press-fitting the laser light source 921 into the laser holder 922 for installation onto the base 91, equipment for producing the laser holder 922 is required, resulting in taking a lot of time and effort in machining. Also, in the case of attaching the laser light source 921 to the laser holder 922, it is often the case that the laser light source 921 is press-fitted and fixed into a hole that is provided in the laser holder 922, resulting in a high possibility of an unreasonable force to the laser light source 921, which may cause the laser beam emitting portion to face an unexpected direction and/or cause the laser light source 921 to be scratched and/or damaged.

Further, since the laser light source 921 is press-fitted into the laser holder 922, it is difficult to detach the laser light source 921 from the laser holder 922. Therefore, in the case of replacing the laser light source 921 or the laser holder 922 when there is a problem, etc., it is necessary to replace both the laser light source 921 and the laser holder 922, resulting in a lot of wastefulness compared to the case of replacing only one of them.

In the invention described in Japanese Patent Laid-Open Publication No. 2005-108300, engaging portions of the holder are adapted to be engaged with to-be-engaged portions of the stem portion in the laser diode, and in the case of the holder being inserted deeply into the optical base, only a small part of the stem portion is to be engaged with the holder, which can result in insufficient engagement between the engaging portions and the to-be-engaged portions.

### SUMMARY OF THE INVENTION

Hence, an object of the present invention is to save time and effort for operations in assembling and in detaching a radiation cover member when replacing and/or maintaining internal parts as well as to improve the assembling accuracy of the products.

In order to achieve the foregoing object, the present invention is directed to an optical head including: a laser light source for emitting a laser beam; a grating for extracting light of specific wavelengths from the laser beam; a half mirror for reflecting a part of the laser beam and for transmitting the rest part; a collimator lens for converting the laser beam into parallel light; an objective lens for applying the laser beam to an optical disk; a light receiving element for receiving and converting light into an electrical signal; an act base for holding the objective lens; a base for fixing the laser light source, the grating, the half mirror, the light receiving element, and the act base thereon; a cover member to be installed in such a manner as to cover the bottom surface of the base; and a wiring board for supplying power to the laser light source, wherein the laser light source includes: a laser emitting portion for emitting a laser beam; a flange portion formed adjacent to the laser emitting portion; and a power supply portion protruding from the flange portion on the side opposite to the laser emitting portion with respect to the flange portion, in the side peripheral wall of the flange portion being formed a key groove having a rectangular cross-section and two recessed grooves symmetrically with respect to the center axis, the base including a key adapted to be engaged with the key groove formed in the side surface of the flange portion, convex strips adapted to be engaged with the recessed grooves formed in the side surface of the flange portion, and a light source installing portion having: a light source insertion hole for inserting therein the laser emitting portion and a part of the flange portion of the laser light source; two bosses facing each other across the light source insertion hole; and two female screw holes facing each other across the light source insertion hole and arranged in positions different from those of the bosses, and the cover member includes: a cover portion having a shape that covers the entire bottom surface of the base, the cover portion having a grating adjustment window for adjusting the grating and a tilt adjustment window for adjusting the tilt of an actuator; and a light source support portion having a cylindrical recessed light source contact portion adapted to be in contact with a part of the laser light source that protrudes from the light source insertion hole, a light source through hole formed in the light source contact portion for passage of the power supply portion of the laser light source, boss holes for passage of the bosses, and bolt holes to be overlapped with the female screw holes, in the light source contact portion being formed a convex portion adapted to be engaged with the key groove in the laser light source, and wherein the convex portion is engaged with the key groove, the light source through hole is arranged in such a manner that the power supply portion penetrates therethrough, and the power supply portion protruding from the cover member is connected with the wiring board, and the cover member can be fixed to the base by engaging the boss holes in the cover member with the bosses on the base as well as engaging the light source contact portion with a part of the laser light source that protrudes from the light source insertion hole and by screwing bolts into the female screw holes through the bolt holes.

In accordance with the arrangement above, the cover member can be fixed to the base by engaging the boss holes in the cover member with the bosses on the base as well as engaging the light source contact portion with a part of the laser light source that protrudes from the light source insertion hole and by screwing the bolts into the female screw holes through the bolt holes.

When inserting the laser light source, since the rotation angle around the axis is specified, the rotation of the laser light source can be prevented and the laser light source can be installed in an appropriate direction and at an appropriate angle by attaching the cover member to the base with the convex portion on the cover member being engaged with the key groove in the laser light source.

Thus, even if it may be necessary to detach the cover member when replacing and/or maintaining parts, it is possible to perform operations without detaching the laser light source from the cover member. Further, since the rotation of the laser light source is prevented, the key groove in the laser light source can be engaged with the key in the light source insertion hole when attaching the cover member, which allows for smooth and rapid installation.

In order to achieve the foregoing object, the present invention is also directed to an optical head including: a laser light source for emitting a laser beam; a base for fixing the laser light source thereon; and a cover member to be installed in such a manner as to cover the bottom surface of the base, wherein the laser light source includes: a laser emitting portion for emitting a laser beam; a flange portion formed adjacent to the laser emitting portion; and a power supply portion protruding from the flange portion on the side opposite to the laser emitting portion with respect to the flange portion, in the side peripheral wall of the flange portion being formed a key groove having a rectangular cross-section, the base including a key adapted to be engaged with the key groove formed in the side surface of the flange portion and a light source installing portion having: a light source insertion hole for inserting therein the laser emitting portion and a part of the flange portion of the laser light source; at least one boss arranged in the vicinity of the light source insertion hole; and at least one female screw hole arranged in the vicinity of the light source insertion hole and in a position different from that of the boss, and the cover member includes: a cover portion having a shape that covers the entire bottom surface of the base, the cover portion having a grating adjustment window for adjusting a grating and a tilt adjustment window for adjusting the tilt of an actuator; and a light source support portion having a cylindrical recessed light source contact portion adapted to be in contact with a part of the laser light source that protrudes from the light source insertion hole, a light source through hole formed in the light source contact portion for passage of the power supply portion of the laser light source, a boss hole for passage of the boss, and a bolt hole to be overlapped with the female screw hole, in the light source contact portion being formed a convex portion adapted to be engaged with the key groove in the laser light source, and wherein the convex portion is engaged with the key groove, the light source through hole is arranged in such a manner that the power supply portion penetrates therethrough, and the power supply portion protruding from the cover member is connected with a wiring board.

In accordance with the arrangement above, the cover member can be fixed to the base by engaging the boss hole in the cover member with the boss on the base as well as engaging the light source contact portion with a part of the laser light source that protrudes from the light source insertion hole and by screwing a bolt into the female screw hole through the bolt hole.

When inserting the laser light source, since the rotation angle around the axis is specified, the rotation of the laser light source can be prevented and the laser light source can be installed in an appropriate direction and at an appropriate angle by attaching the cover member to the base with the convex portion on the cover member being engaged with the key groove in the laser light source.

Thus, even if it may be necessary to detach the cover member when replacing and/or maintaining parts, it is possible to perform operations without detaching the laser light source from the cover member. Further, since the rotation of the laser light source is prevented, the key groove in the laser light source can be engaged with the key in the light source insertion hole when attaching the cover member, which allows for smooth and rapid installation.

In accordance with the present invention, there is provided an optical head in which a radiation cover member can be detached with being engaged with a laser light source when replacing and/or maintaining internal parts and the laser light source and the cover member can be installed in such a manner that the angle of the laser light source in the rotational direction is made accurate.

### BRIEF DESCRIPTION OF THE DRAWINGS

FIG. 1 is a view showing an arrangement in an optical disk apparatus according to the present invention;

FIG. 2 is a plan view of an optical head according to the present invention;

FIG. 3 is a bottom view of the optical head shown in FIG. 2;

FIG. 4 is a side view of the optical head shown in FIG. 2;

FIG. 5 (A) is an enlarged cross-sectional view of the laser light source installing portion shown in FIG. 2 and FIG. 5 (B) is an enlarged side view of the light source installing portion shown in FIG. 5 (A);

FIG. 6 (A) is a disassembled perspective view showing a laser light source and a cover member in the optical head according to the present invention, FIG. 6 (B) is a side view of the cover member in the optical head according to the present invention, and FIG. 6 (C) is an enlarged side view of a light source contact portion;

FIG. 7 is a view showing an arrangement in an optical head; and

FIG. 8 (A) is a bottom view of a conventional optical head and FIG. 8 (B) is a side view of the optical head shown in FIG. 8 (A).

### DESCRIPTION OF THE PREFERRED EMBODIMENTS

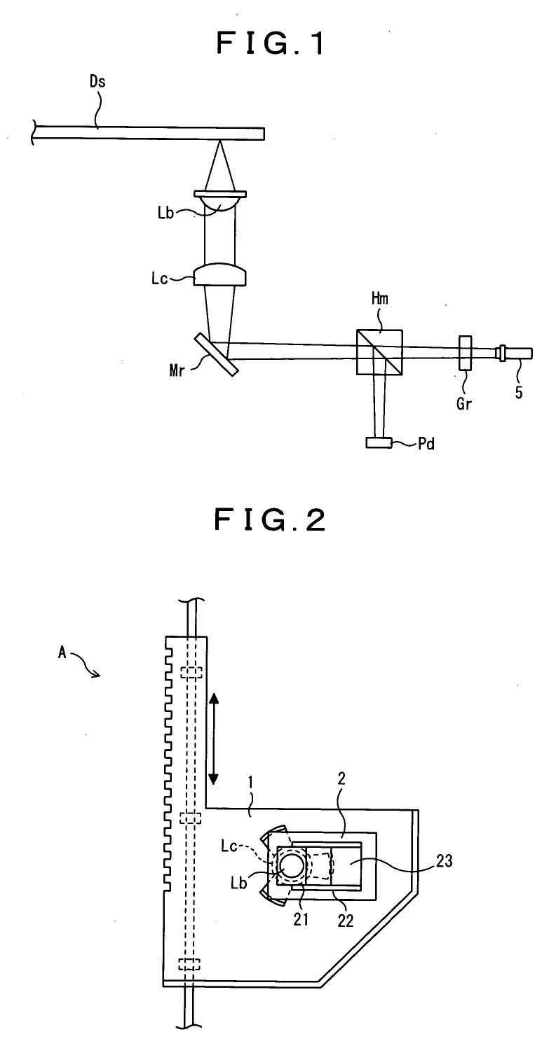

Embodiments of the present invention will hereinafter be described with reference to the accompanying drawings. FIG. 1 is a view showing an arrangement in an optical head. The optical head shown in FIG. 1 is, for example, a read-only optical head for reading data recorded on an optical disk, though not restricted thereto. As shown in FIG. 1, there are provided a laser light source 5, a grating Gr for extracting light of specific wavelengths from a laser beam emitted from the laser light source 5, a mirror Mr, a collimator lens Lc, an objective lens Lb, a half mirror Hm, and a light receiving element Pd. A laser beam emitted from the laser light source 5 undergoes extraction of specific wavelengths in the grating Gr and is reflected at the mirror Mr to enter the collimator lens Lc. The laser beam incident to the collimator lens Lc is output as parallel light to enter the objective lens Lb. The laser beam incident to the objective lens Lb is applied to the recording surface of an optical disk Ds.

In the case above, the laser beam is applied focusing on the recording layer of the optical disk Ds with the optical axis thereof being perpendicular to the recording layer of the optical disk Ds. The half mirror Hm is a mirror for transmitting a half of the incident laser beam and for reflecting the other half, adapted to guide the light reflected at the optical disk Ds toward the light receiving element Pd. The light receiving element Pd is adapted to convert light into current and to read data based on the intensity of the light. Optical heads capable of recording data onto an optical disk have basically the same configuration. The order of applying a laser beam to the above-described members is not restricted thereto, but may be permuted to the extent possible.

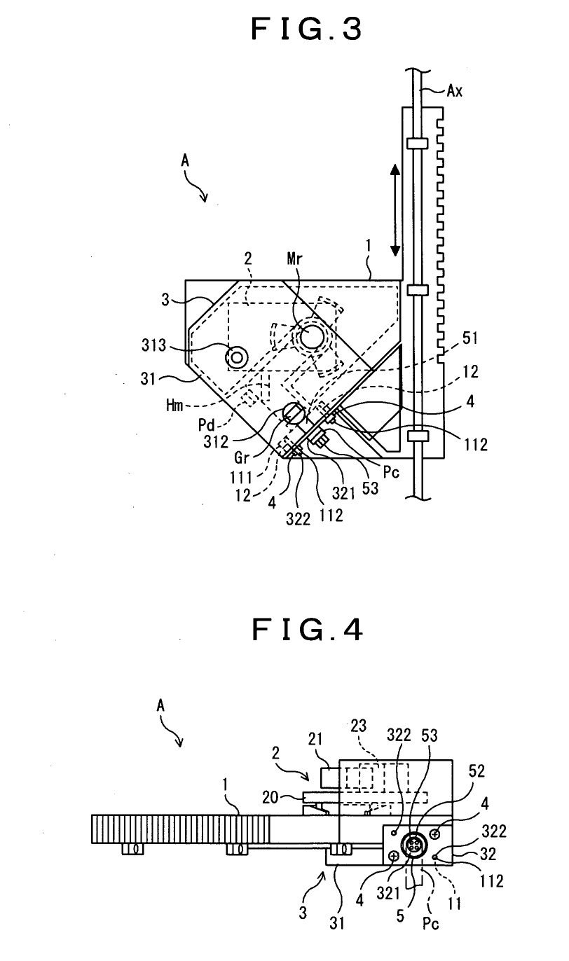

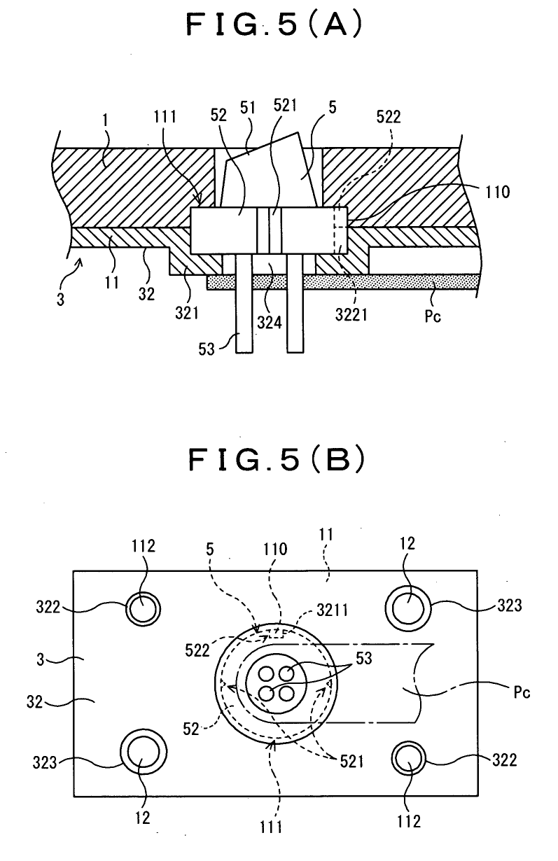

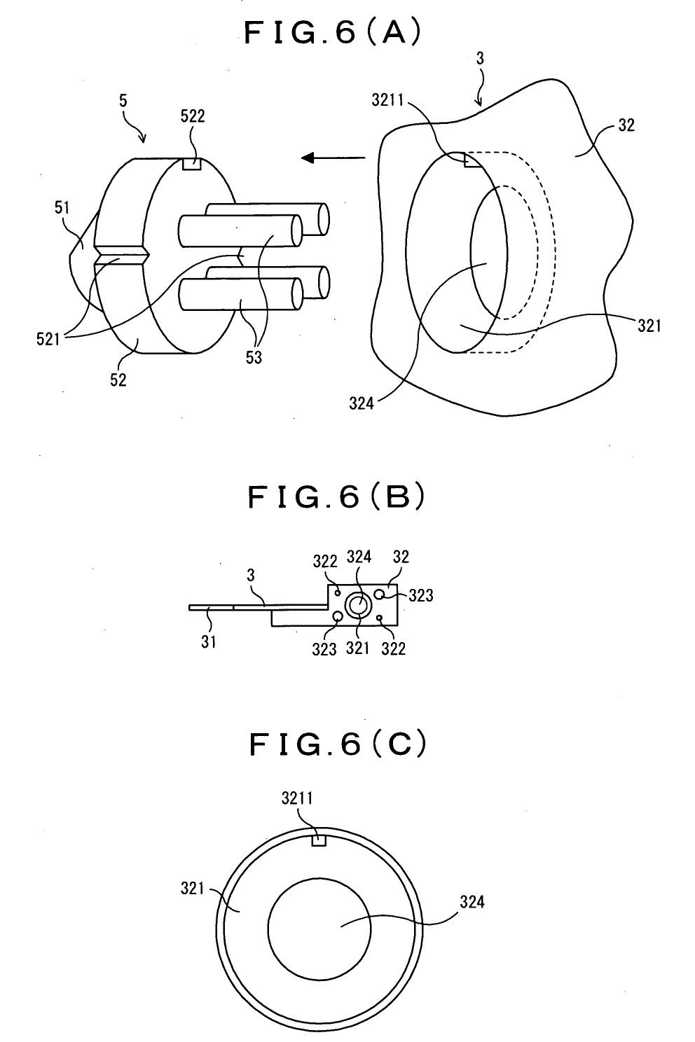

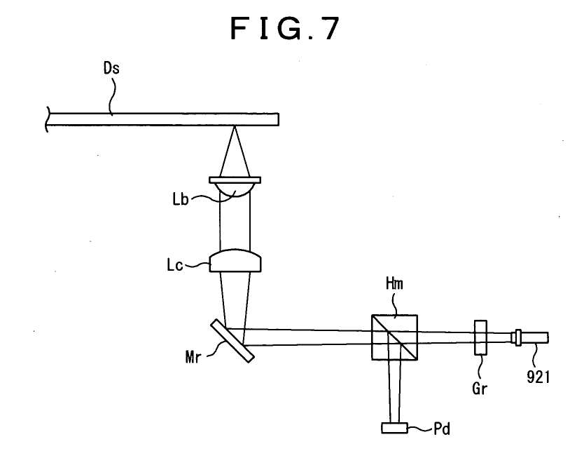

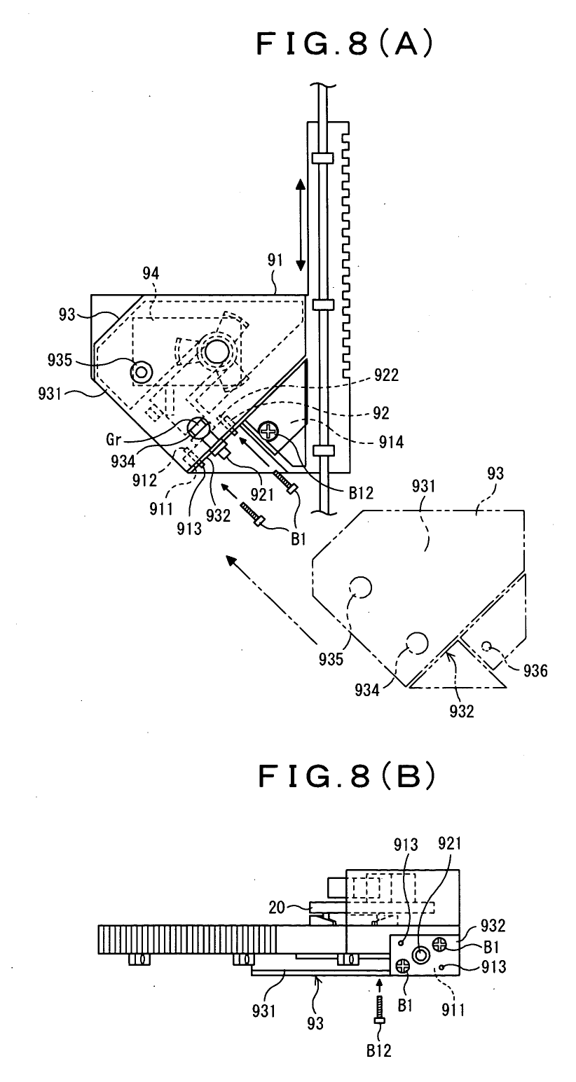

FIG. 2 is a plan view of an optical head according to the present invention; FIG. 3 is a bottom view of the optical head shown in FIG. 2; FIG. 4 is a side view of the optical head shown in FIG. 2; FIG. 5 (A) is an enlarged cross-sectional view of the laser light source installing portion shown in FIG. 2 and FIG. 5 (B) is an enlarged side view of the light source installing portion shown in FIG. 5 (A); and FIG. 6 (A) is a disassembled perspective view showing a laser light source and a cover member in the optical head according to the present invention, FIG. 6 (B) is a side view of the cover member in the optical head according to the present invention, and FIG. 6 (C) is an enlarged side view of a light source contact portion. The optical head A has a base 1, an actuator 2, and a cover member 3 for covering the bottom surface of the base 1.

On a side surface of the base 1, there is provided a light source installing portion 11 for installing the laser light source 5 thereon. As shown in FIGS. 3 and 4, the light source installing portion 11 includes: a light source insertion hole 111 for inserting the laser light source 5 therein in approximately the center of the portion; two bosses 112 on either side of the light source insertion hole 111; and two female screw holes 12 on either side of the light source insertion hole 111 and in positions not to be overlapped with the bosses 112.

The laser light source 5 has a laser emitting portion 51, a flange portion 52 for supporting the laser emitting portion 51, and power supply portions 53 formed on the side opposite to the laser emitting portion 51 with respect to the flange portion 52. The flange portion 52 is formed in a cross-sectionally circular shape, in the side surface of the flange portion 52 being formed two recessed grooves 521. The recessed grooves 521 are arranged symmetrically with respect to the center of the flange portion 52. The flange portion 52 is fitted partially into the light source insertion hole 111, and there are formed convex strips each having a shape engageable with each recessed groove 521 in the positions of the light source insertion hole 111 that correspond to those of the recessed grooves 521. It is thus possible to prevent the laser light source 5 from being rotated by inserting the laser light source 5 into the light source insertion hole 111 in such a manner that the recessed grooves 521 are engaged with the convex strips (refer to FIGS. 5 and 6).

Further, a cross-sectionally rectangular-shaped key groove 522 is formed in the side surface of the flange portion 52 of the laser light source 5, while a key 110 adapted to be engaged with the key groove 522 is formed in the light source insertion hole 111. The accuracy of the installation angle (in the rotational direction) of the laser light source 5 can be improved easily by inserting the laser light source 5 into the light source insertion hole 111 in such a manner that the key 110 in the light source insertion hole 111 is engaged with the key groove 522 in the laser light source 5 (refer to FIG. 5 (B)).

The actuator 2 has an act base 20, a lens holder 21 for holding the objective lens Lb, and a support portion 23 for supporting the lens holder 21 via a wire spring 22. The actuator 2 is adapted to perform tracking adjustment and focusing adjustment, etc. for the objective lens Lb by moving the lens holder 21 using a tracking coil and a focusing coil, etc. not shown in the figures. The actuator 2 is adjusted so that laser beams are applied to the recording surface of an optical disk Ds at an appropriate angle and then is arranged and fixed onto the base 1.

The cover member 3 includes a cover portion 31 for covering the bottom surface of the base 1 and a laser light source support portion 32 formed perpendicularly to the cover portion 31 to support the laser light source 5. The cover member 3 is formed by, for example, cutting and bending aluminum plate through press working, though not restricted thereto.

The cover portion 31 of the cover member 3 has: a grating adjustment window 312 formed in a position to be overlapped with a grating arranging portion to adjust the grating Gr; and a tilt adjustment window 313 for adjusting the tilt of the actuator 2 (refer to FIG. 3).

Also, the laser light source support portion 32 has: a cylindrical recessed light source contact portion 321 adapted to be engaged with a protruding part of the laser light source 5 installed in the light source insertion hole 111 that is formed in the light source installing portion 11; boss holes 322 adapted to be engaged with the bosses 112 that are provided on the light source installing portion 11; and bolt holes 323 formed in such a manner as to be overlapped with the female screw holes 12 that are formed in the light source installing portion 11.

Further, in the central part of the light source contact portion 321, there is formed a light source through hole 324 for passage of the power supply portions 53, which are for supplying power to the laser light source 5, through the cover member 3. The light source contact portion 321 of the cover member 3 is adapted to cover and come into contact with a part of the laser light source 5 that protrudes from the light source insertion hole 111 (flange portion 52 of the laser light source 5) (refer to FIGS. 5 (A) and 5 (B)).

Thus, heat generated from the laser light source 5 is transferred to the light source contact portion 321 of the cover member 3. The heat transferred to the light source contact portion 321 travels through the laser light source support portion 32 and the cover portion 31 of the cover member 3 to be released into the atmosphere from a part of the cover member 3 that is in contact with the atmosphere. That is, since heat generated from the laser light source 5 is released effectively, it is possible to prevent the output of the laser light source 5 from being degraded due to overheating.

When attaching the cover member 3 to the bottom surface of the base 1, the bosses 112 formed on the light source installing portion 11 of the base 1 are first engaged with the boss holes 322 formed in the laser light source support portion 32 of the cover member 3. Engaging the bosses 112 with the boss holes 322 allows the cover member 3 to be positioned appropriately with respect to the base 1. That is, the light source contact portion 321 in the laser light source support portion 32 of the cover member 3 is brought into contact with a part of the laser light source 5, which is inserted in the light source insertion hole 111, that protrudes from the light source insertion hole 111.

In the case above, the female screw holes 12 provided in the light source installing portion 11 and the bolt holes 323 in the laser light source support portion 32 of the cover member 3 are arranged in such a manner as to be overlapped with each other. By screwing bolts 4 into the female screw holes 12 through the bolt holes 323 in this state, the cover member 3 can be fixed to the base 1. In the state where the cover member 3 is installed, the power supply portions 53 of the laser light source 5 are exposed from the light source through hole 324 in the laser light source support portion 32.

The power supply portions 53 are connected with a wiring board Pc mounted on the base 1 to connect a control board not shown in the figures and the power supply portions 53. The wiring board Pc is mounted in such a manner as to come into contact with the laser light source support portion 32 on the side opposite to the flange portion 52 with respect to the cover member 3. The wiring board Pc employs FPC (Flexible Print Circuit), which is unlikely to be disconnected even if bent and/or twisted, so that power can be supplied even if the laser light source support portion 32 of the cover member 3 and the control board may be arranged in a twisted manner (refer to FIGS. 3, 4, and 5).

In addition, since the grating adjustment window 312 for accessing the grating Gr is formed in the cover portion 31 of the cover member 3, the grating Gr can be adjusted without detaching the cover member 3. Further, since there is also formed the tilt adjustment window 313 in which a screw (not shown in the figures) for adjusting the tilt of the actuator 2 that is arranged on the obverse side of the base 1 is inserted, the tilt of the actuator 2 can be adjusted even if the cover member 3 may be attached.

Attaching the cover member 3 to the base 1 can prevent the laser light source 5, half mirror Mr, and light receiving element Pd, etc. from being damaged and/or breaking down due to contact with articles and/or adhesion of dust. Also, since it is possible to prevent the incidence of light other than laser beams from outside the optical head A, there is no possibility of incorporation and interference of spurious light with laser beams incident to the light receiving element Pd, whereby the laser beams can be converted into appropriate electrical signals in the light receiving element Pd. Further, since heat generated from the laser light source 5 can be released efficiently, the possibility of trouble such as breakage and/or failure due to heat in the optical head A can be reduced accordingly.

On the light source contact portion 321 in the laser light source support portion 32 of the cover member 3, there is formed a convex portion 3211 adapted to be engaged with the key groove 522 that is formed in the flange portion 52 of the laser light source 5. The convex portion 3211 is formed in such a manner that the convex portion 3211 on the cover member 3 is engaged with the key groove 522 in the flange portion 52 when attaching the cover member 3 to the base 1.

In the case of reworking the optical head A such as replacing or maintaining optical elements mounted on the base 1, it is necessary to detach the cover member 3 from the base 1. The power supply portions 53 of the laser light source 5 and the wiring board Pc are fixed to each other, and the cover member 3 is detached from the base 1 with the laser light source 5 being held by the cover member 3. In this case, since the key groove 522 formed in the flange portion 52 of the laser light source 5 is engaged with the convex portion 3211 formed on the light source contact portion 321, the laser light source 5 is supported by the laser light source support portion 32 of the cover member 3 while being kept at a constant rotation angle.

By attaching the cover member 3 to the base 1 in the state above, the laser light source 5 can be inserted in such a manner that the recessed grooves 521 formed in the flange portion 52 of the laser light source 5 are engaged with the convex strips formed in the light source insertion hole 111 and that the key groove 522 in the flange portion 52 is engaged with the key 110 in the light source insertion hole 111 without adjusting the angle of the laser light source 5 in the rotational direction. This allows the laser light source 5 to be inserted into the light source insertion hole 111 in the base 1 at an appropriate angle without adjusting the angle of the laser light source 5 in the rotational direction for each de-installation/installation of the cover member 3. It is accordingly possible to reduce time and effort in assembling. It is also possible to prevent breakage due to erroneous assembling.

Although the flange portion 52 includes, for example, two recessed grooves 521 and one key groove 522 in the descriptions of the above-described embodiment, the arrangement is not restricted thereto, and it is possible to widely employ arrangements whereby the rotation of the laser light source 5 can be prevented and the angle in the rotational direction can be specified appropriately such as including no recessed groove or including a plurality of key grooves 522.

The optical head according to the present invention is applicable to optical disk apparatuses for reading information by applying a laser beam to an optical disk such as DVD, CD, or LD and/or for recording information onto a writable optical disk.

What is claimed is:

1. An optical head comprising:
a laser light source for emitting a laser beam;
a grating for extracting light of specific wavelengths from said laser beam;
a half mirror for reflecting a part of said laser beam and for transmitting the rest part;
a collimator lens for converting said laser beam into parallel light;
an objective lens for applying said laser beam to an optical disk;
a light receiving element for receiving and converting light into an electrical signal;
an act base for holding said objective lens;
a base for fixing said laser light source, said grating, said half mirror, said light receiving element, and said act base thereon;
a cover member to be installed in such a manner as to cover the bottom surface of said base; and
a wiring board for supplying power to said laser light source, wherein
said laser light source comprises: a laser emitting portion for emitting a laser beam; a flange portion formed adjacent to said laser emitting portion; and a power supply portion protruding from said flange portion on the side opposite to said laser emitting portion with respect to said flange portion, in the side peripheral wall of said flange portion being formed a key groove having a rectangular cross-section and two recessed grooves symmetrically with respect to the center axis,
said base comprising a key adapted to be engaged with said key groove formed in the side surface of said flange portion, convex strips adapted to be engaged with said recessed grooves formed in the side surface of said flange portion, and a light source installing portion having: a light source insertion hole for inserting therein said laser emitting portion and a part of said flange portion of said laser light source; two bosses facing each other across said light source insertion hole; and two female screw holes facing each other across said light source insertion hole and arranged in positions different from those of said bosses, and
said cover member comprises: a cover portion having a shape that covers the entire bottom surface of said base, said cover portion having a grating adjustment window for adjusting said grating and a tilt adjustment window for adjusting the tilt of an actuator; and a light source support portion having a cylindrical recessed light source contact portion adapted to be in contact with a part of said laser light source that protrudes from said light source insertion hole, a light source through hole formed in said light source contact portion for passage of said power supply portion of said laser light source, boss holes for passage of said bosses, and bolt holes to be overlapped with said female screw holes,
in said light source contact portion being formed a convex portion adapted to be engaged with said key groove in said laser light source, and wherein
said convex portion is engaged with said key groove, said light source through hole is arranged in such a manner that said power supply portion penetrates therethrough, and said power supply portion protruding from said cover member is connected with said wiring board, and
said cover member can be fixed to said base by engaging said boss holes in said cover member with said bosses on said base as well as engaging said light source contact portion with a part of said laser light source that protrudes from said light source insertion hole and by screwing bolts into said female screw holes through said bolt holes.

2. An optical head comprising:
a laser light source for emitting a laser beam;
a grating for extracting light of specific wavelengths from said laser beam;
a half mirror for reflecting a part of said laser beam and for transmitting the rest part;
a collimator lens for converting said laser beam into parallel light;
an objective lens for applying said laser beam to an optical disk;
a light receiving element for receiving and converting light into an electrical signal;
an act base for holding said objective lens;
a base for fixing said laser light source, said grating, said half mirror, said light receiving element, and said act base thereon;
a cover member to be installed in such a manner as to cover the bottom surface of said base; and
a wiring board for supplying power to said laser light source, wherein
said laser light source comprises: a laser emitting portion for emitting a laser beam; a flange portion formed adjacent to said laser emitting portion; and a power supply portion protruding from said flange portion on the side opposite to said laser emitting portion with respect to said flange portion, in the side peripheral wall of said flange portion being formed a key groove having a rectangular cross-section and two recessed grooves symmetrically with respect to the center axis,
said base comprising a key adapted to be engaged with said key groove formed in the side surface of said flange portion, convex strips adapted to be engaged with said recessed grooves formed in the side surface of said flange portion, and a light source installing portion having: a light source insertion hole for inserting therein said laser emitting portion and a part of said flange portion of said laser light source; two bosses facing each other across said light source insertion hole; and two female screw holes facing each other across said light source insertion hole and arranged in positions different from those of said bosses, and
said cover member comprises: a cover portion having a shape that covers the entire bottom surface of said base, said cover portion having a grating adjustment window for adjusting said grating and a tilt adjustment window for adjusting the tilt of an actuator; and a light source support portion having a cylindrical recessed light source contact portion adapted to be in contact with a part of said laser light source that protrudes from said light source insertion hole, a light source through hole formed in said light source contact portion for passage of said power supply portion of said laser light source, boss holes for passage of said bosses, and bolt holes to be overlapped with said female screw holes,
in said light source contact portion being formed a convex portion adapted to be engaged with said key groove in said laser light source, and wherein
said convex portion is engaged with said key groove, said light source through hole is arranged in such a manner that said power supply portion penetrates therethrough, and said power supply portion protruding from said cover member is connected with said wiring board.

3. An optical head comprising:
a laser light source for emitting a laser beam;
a base for fixing said laser light source thereon; and
a cover member to be installed in such a manner as to cover the bottom surface of said base, wherein
said laser light source comprises: a laser emitting portion for emitting a laser beam; a flange portion formed adjacent to said laser emitting portion; and a power supply portion protruding from said flange portion on the side opposite to said laser emitting portion with respect to said flange portion, in the side peripheral wall of said flange portion being formed a key groove having a rectangular cross-section,
said base comprising a key adapted to be engaged with said key groove formed in the side surface of said flange portion and a light source installing portion having: a light source insertion hole for inserting therein said laser emitting portion and a part of said flange portion of said laser light source; at least one boss arranged in the vicinity of said light source insertion hole; and at least one female screw hole arranged in the vicinity of said light source insertion hole and in a position different from that of said boss, and
said cover member comprises: a cover portion having a shape that covers the entire bottom surface of said base, said cover portion having a grating adjustment window for adjusting a grating and a tilt adjustment window for adjusting the tilt of an actuator; and a light source support portion having a cylindrical recessed light source contact portion adapted to be in contact with a part of said laser light source that protrudes from said light source insertion hole, a light source through hole formed in said light source contact portion for passage of said power supply portion of said laser light source, a boss hole for passage of said boss, and a bolt hole to be overlapped with said female screw hole,
in said light source contact portion being formed a convex portion adapted to be engaged with said key groove in said laser light source, and wherein
said convex portion is engaged with said key groove, said light source through hole is arranged in such a manner that said power supply portion penetrates therethrough, and said power supply portion protruding from said cover member is connected with a wiring board.
